(19) United States
(12) Patent Application Publication
(10) Pub. No.: US 2006/0105095 A1
(43) Pub. Date: May 18, 2006

(54) Process of freezing fresh pureed fruits, vegetables and meats to produce a healthy frozen baby food product

(76) Inventors: Raquel Anthony, Menifee, CA (US); John Anthony, Menifee, CA (US)

Correspondence Address: Raquel L. Anthony, 29187 Woodbine Lame, Menifee, CA, 92584, US

(21) Appl. No.: 10/989,908

(22) Filed: Nov. 15, 2004

(51) Int. Cl. A01J 25/00; A23P 1/00

(52) U.S. Cl. 426/615; 426/519

(57) ABSTRACT

What we claim as our invention is the process of taking organic and non-organic fruits, vegetables, and meats and creating a frozen baby food product with no artificial additives or artificial sweetners.

This invention pertains to the process of taking a variety of organic and non-organic fruits, vegetables and cooked meats, pureed and then frozen in convenient packaging to make a wholesome and convenient food for babies and babies parents.

Preferably, foods will be purchased from organic certified growers, (but not restricted to) Foods will be prepared within 24 hours of being picked from the farms.

The process of preparing baby food to be as follows: Wash and rinse food. Some foods will be cooked, by method of boil, bake, steam or any suitable method.

Foods will then be pureed or softened by hand or machine to obtain the necessary consistancy for appropriate ages of child development. Foods may be strained and water or natural juices may be added.

Baby food can be packaged individually into single servings for convenient travel use and then frozen directly in its packaging or food items can be frozen into ice-cube like trays where they will be covered and protected from freezer contamination.

After freezing in trays, food cubes will be removed from trays, then placed in approximately 2 lb. resealable freezer bags. These approximate 2 lb. single or combination flavor bags will be combined with several other single or combination flavor bags to equal an approximate 4-10 lb. bag with a mixed variety of food items.

### CROSS-REFERENCE TO RELATED APPLICATIONS

N/A

### STATEMENT REGARDING FEDERALLY SPONSORED RESEARCH OR DEVELOPMENT

In the 1990's FDA deems frozen fruit and vegetable products to have equivalent or superior nutrient profiles as their fresh counterparts.

Organic is a labeling term that denotes products produced under the Organic Foods Protection Act. The principal guidelines for organic production are to use materials and practices that enhance ecological balance of natural systems and that integrate the parts of the farming system into an ecological whole.

### REFERENCE TO SEQUENCE LISTING, A TABLE, OR A COMPUTER PROGRAM LISTING COMPACT DISK APPENDIX

N/A

### BACKGROUND OF THE INVENTION

This invention pertains to food subject matter. It references pureed organic and non-organic baby foods and frozen foods. The process of individually freezing servings has proven to allow for easy seperation of servings and offer less waste of product. One will be able to take out only what they will expect to consume. For example: a child of 6 months may have a healthier appetite at lunch times and therefore, a parent may wish to thaw 3 cubes for a child's lunch time meal oppose to breakfast time where the child may have a much smaller appetite and only consume two food cubes.

The process of freezing fresh fruits, vegetables, and meats has been around since the early 1900's. However, pureeing and then freezing is unique to the baby food industry. For many decades baby food has been canned, jarred, bagged and boxed. This process will be highly desirable to parents who may wish to feed their babies whole, pure, nutrient rich baby foods and may not have the time or resources to do so.

Frozen foods are the height of convenience. By using basic frozen ingredients such as vegetables, fruits and meats, we can help the consumer get a fresh, tasty and nutritious meal to babies and toddlers. Frozen fruits and vegetables are often more nutritious than their counterparts because freezing preserves the majority of nutrients in foods even when frozen for an extended period of time. Freezing prevents food spoilage by inhibiting microorganic and enzyme action and generally involves less loss of taste, flavor, and appearance than do other methods. In the 1990's FDA deems frozen fruit and vegetable products to have equivalent or superior nutrient profiles as their fresh counterparts. According the NPD Group, Inc. the frozen meal category has continued it's steady growth over the past 10 years. Statistics prove the desire, relevance, and need for this product.

Organic is a labeling term that denotes products produced under the Organic Foods Production Act. The principal guidelines for organic production are to

### BRIEF DESCRIPTION OF THE SEVERAL VIEWS OF THE DRAWING

N/A

### DETAILED DESCRIPTION OF THE INVENTION

This invention pertains to frozen human baby food consisting of a variety of organic and non organic fruits, vegetables and cooked meats in their most natural and purest form suitable for human consumption and then freezing to preserve the level of nutrients of raw fruits and vegetable.

The process of preparing baby food to be as follows: Wash and rinse food. Some foods will be cooked, by method of boil, bake, steam or any suitable method.

Foods will then be pureed or softened by hand or machine to obtain the necessary consistancy for appropriate ages of child development. Foods may be strained and water or natural juices may be added.

Baby food can be packaged individually into single serve for convenient travel use and then frozen directly in its packaging or food items can be frozen into ice-cube like trays where they will be covered and protected from freezer contamination.

After freezing in trays, food cubes will be removed from trays, and then placed in approximately 2 lb. resealable freezer bags or other convenient re-entry packaging. These approximate 2 lb. single flavor bags will be combined with several other single flavor bags to equal an approximate 8-10 lb. bag with a mixed variety of food items. use materials and practices that enhance ecological balance of natural systems and that integrate the parts of the farming system into an ecological whole. Farmers must grow produce for 3 years without the application of synthetic pesticides or chemical. The farm, it's equipment and any processing facilities are all inspected by an independent agent unaffiliated with the grower, the processor and the vender and are then issued certificates from that agency certifying the farms produce as “organic”. Certified Organic produce is not essentially healthier than produce that has been grown under non-organic conditions. The nutritional content of a particular vegetable dose not change but the lack of synthetic pesticidal residues on organically grown produce definitely makes for a safer product.

### BRIEF SUMMARY OF THE INVENTION

This invention pertains to natural organic and non-organic frozen baby food consisting of a variety of organic fruits, vegetables and cooked meats in their most natural and purest form suitable for human consumption. Foods will be pureed (but not limited to) and then frozen to different consistencies, according to the different stages of child development. Portions may be frozen into small portions, individually packaged servings, or ice-cube like form without adding preservatives, additives, or artificial sweeteners. Portions may be stored in large quantity packaging or individually packaged for convenient travel use.

1. What we claim as our invention is the process of taking fresh organic and non-organic fruits, vegetables, and meats to create a frozen baby food product with no additives or artificial sweeteners. Washing and cooking when necessary. Pureeing to a consistency safe for babies consumption (but not limited to), and then freezing to preserve the level of freshness, nutrients and vitamins of raw fruits and vegetables and fresh meats.

2. The frozen baby food product of claim one may consist of variations of combinations as set forth; fruits with other fruits, vegetables with other vegetables, meats with other meats, fruits with vegetables, fruits with meats, vegetables with meat, or single item foods.

3. Food products of claim one may be non-organic or organic certified.

4. Food products of claim one may consist of virtually any type of fruit or vegetable safe for human consumption.

5. Cooking methods of claim one may consist of (but not limited to) boil, bake, steam, broil, saute, or any suitable method.

6. Washing methods of claim one will consist of merely rinsing and rubbing dirt or debris from fruit.

7. Freezing methods of claim one will consist of flash freezing or conventional freezing methods.

8. Pureeing method of claim one may consist of mashing, grinding, whipping, chopping or any suitable method necessary to obtain the appropriate consistency safe for the consumption of small children.

9. Packaging method of claim one shall consist of individually wrapped single servings or individually frozen portions combined into large quantities for retail or wholesale distribution. Quantities may vary. Serving size and portions may vary.
